(19) United States
(12) Patent Application Publication
(10) Pub. No.: US 2007/0115583 A1
(43) Pub. Date: May 24, 2007

(54) Perpendicular write head with shaped pole tip to optimize magnetic recording performance

(75) Inventors: Christian Rene Bonhote, San Jose, CA (US); Quang Le, San Jose, CA (US); Byron Hassberg Lengsfield III, Gilroy, CA (US); Jui-Lung Li, San Jose, CA (US); Scott Arthur MacDonald, San Jose, CA (US); Petrus Antonius Van Der Heijden, San Jose, CA (US)

Correspondence Address: ZILKA-KOTAB, PC, P.O. BOX 721120, SAN JOSE, CA, 95172-1120, US

(73) Assignee: HITACHI GLOBAL STORAGE TECHNOLOGIES

(21) Appl. No.: 11/286,026

(22) Filed: Nov. 23, 2005

(51) Int. Cl. G11B 5/33

(52) U.S. Cl. 360/126; 360/317

(57) ABSTRACT

A magnetic write head for perpendicular magnetic recording, the write head having a magnetic write pole configured with a cross section as viewed from the ABS that has a trailing portion with substantially vertical side walls and a leading portion formed with a taper that becomes narrower as it extends toward the leading edge. The write pole provides for excellent write field strength by providing sufficient cross section near the trailing edge to avoid magnetic saturation of the pole tip. The parallel side walls of the trailing portion also provide for excellent track width control during manufacture of the write head. The tapered portion of the write head, which starts some distance away from the trailing edge, prevents skew related adjacent track writing when the actuator that holds the write head is at its innermost or outermost travel extensions.

### FIELD OF THE INVENTION

The present invention relates to perpendicular magnetic recording, and more particularly to a perpendicular magnetic write head having a novel write pole configured for improved write field and reduced skew related adjacent track interference.

### BACKGROUND OF THE INVENTION

At the heart of a computer is a magnetic disk drive that includes a magnetic disk, a slider where a magnetic head assembly including write and read heads is mounted, a suspension arm, and an actuator arm. When the magnetic disk rotates, air adjacent to the disk surface moves with it. This allows the slider to fly on an extremely thin cushion of air, generally referred to as an air bearing. When the slider flies on the air bearing, the actuator arm swings the suspension arm to place the magnetic head assembly over selected circular tracks on the rotating magnetic disk, where signal fields are written and read by the write and read heads, respectively. The write and read heads are connected to processing circuitry that operates according to a computer program to implement write and read functions.

Typically magnetic disk drives have been longitudinal magnetic recording systems, wherein magnetic data is recorded as magnetic transitions formed longitudinally on a disk surface. The surface of the disk is magnetized in a direction along a track of data and then switched to the opposite direction, both directions being parallel with the surface of the disk and parallel with the direction of the data track.

Data density requirements are fast approaching the physical limits, however. For example, increased data capacity requires decreased bit sizes, which in turn requires decreasing the grain size of the magnetic medium. As this grain size shrinks, the magnetic field required to write a bit of data increases proportionally. The ability to produce a magnetic field strong enough to write a bit of data using conventional longitudinal write head technologies is reaching its physical limit.

One means for overcoming this physical limit has been to introduce perpendicular recording. In a perpendicular recording system, bits of data are recorded magnetically perpendicular to the plane of the surface of the disk. The magnetic disk may have a relatively high coercivity material at its surface and a relatively low coercivity material just beneath the surface. A write pole having a small cross section and very high flux emits a strong, concentrated magnetic field perpendicular to the surface of the disk. This magnetic field emitted from the write pole is sufficiently strong to overcome the high coercivity of the surface material and magnetize it in a direction perpendicular to its surface. This flux then flows through the relatively magnetically soft underlayer and returns to the surface of the disk at a location adjacent a return pole of the write element.

The return pole of the write element has a cross section that is much larger than that of the write pole so that the flux through the disk at the location of the return pole (as well as the resulting magnetic field between the disk and return pole) is sufficiently spread out to render the flux too weak to overcome the coercivity of the disk surface material. In this way, the magnetization imparted by the write pole is not erased by the return pole.

Efforts to minimize track width and bit size when using perpendicular recording have focused on the formation of the write pole since the write pole defines the track width. If the write pole is configured with a rectangular cross section, as viewed from the air bearing surface (ABS) problems with adjacent track interference arise. As those skilled in the art will recognize, skew occurs as an actuator arm swings the magnetic head to either extreme of its pivot range (ie. at the inner and outer portions of the disk). Such skew positions the head at an angle, which positions portions of the write pole outside of the desired track.

One way to mitigate this skew related adjacent track interference is to form the write pole with a trapezoidal cross section as viewed from the ABS. Such a trapezoidal shape has the wider portion of the trapezoid at the trailing edge of the write pole where the bit is written. Unfortunately, such a trapezoidal configuration of the write pole restricts write field by reducing the amount of write pole material available for conducting magnetic flux, especially near the trailing edge where the bit is primarily written. This reduced write pole area, or footprint, of the pole tip at the ABS results in a reduced field at the media.

Another problem that arises as a result of such trapezoidal configuration is that it seriously diminishes the ability to control trackwidth during manufacture of the write head. The trapezoidal write pole is constructed by an angled ion mill that removes material from the sides of the write pole, and since the sloped sides of the write pole extend all of the way to the trailing edge of the write pole, any variation of the sloped sides greatly affects the trackwidth of the write pole.

Therefore, there is a strong felt need for a write pole design maximize write field at the media, especially at the trailing edge of the write pole, while also preventing skew related adjacent track interference. Such a write pole would preferably also allow for tight control of the track width of the write pole, since this is one of the most critical parameters in write head design.

### SUMMARY OF THE INVENTION

The present invention provides a magnetic write pole for perpendicular magnetic recording that is configured with a cross section as viewed from the ABS that has a trailing portion with substantially vertical side walls and a leading portion formed with a taper that becomes narrower as it extends toward the leading edge.

The write pole exhibits excellent write field strength by providing sufficient cross section near the trailing edge of the write pole. The parallel side walls of the trailing portion also provide for excellent track width control during manufacture of the write head.

The tapered portion of the write head, which starts some distance away from the trailing edge, prevents skew related adjacent track writing when the actuator that holds the write head is at its innermost or outermost travel extensions.

The constant width portion of the write pole (trailing portion) may extend from the trailing edge to a distance D from the trailing edge. The leading portion may extend from the end of the trailing portion (the distance D from the trailing edge) all the way to the leading edge. The distance from the leading edge to the trailing edge of the write pole defines a length L and D can be, for example 1/10 to ½ L. The width of the leading edge can be 40% to 80% of the width of the trailing edge (ie. the width of the trailing portion).

These and other advantages and features of the present invention will be apparent upon reading the following detailed description in conjunction with the Figures.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic view of a magnetic storage system in which the present invention might be embodied;

FIG. 2 is a cross sectional view of a perpendicular magnetic write element according to an embodiment of the present invention;

FIG. 3 is an ABS view, taken from line 3-3 of FIG. 2, illustrating a write pole according to an embodiment of the present invention;

FIGS. 4-8 are ABS views of a write pole according to an embodiment of the invention, shown in various intermediate stages of manufacture in order to illustrate a method of manufacturing a write head according to an embodiment of the invention; and

FIG. 9 is a top down view of a wafer illustrating an ion mill sweep.

### DETAILED DESCRIPTION OF THE PREFERRED EMBODIMENTS

The following description is the best embodiment presently contemplated for carrying out this invention. This description is made for the purpose of illustrating the general principles of this invention and is not meant to limit the inventive concepts claimed herein.

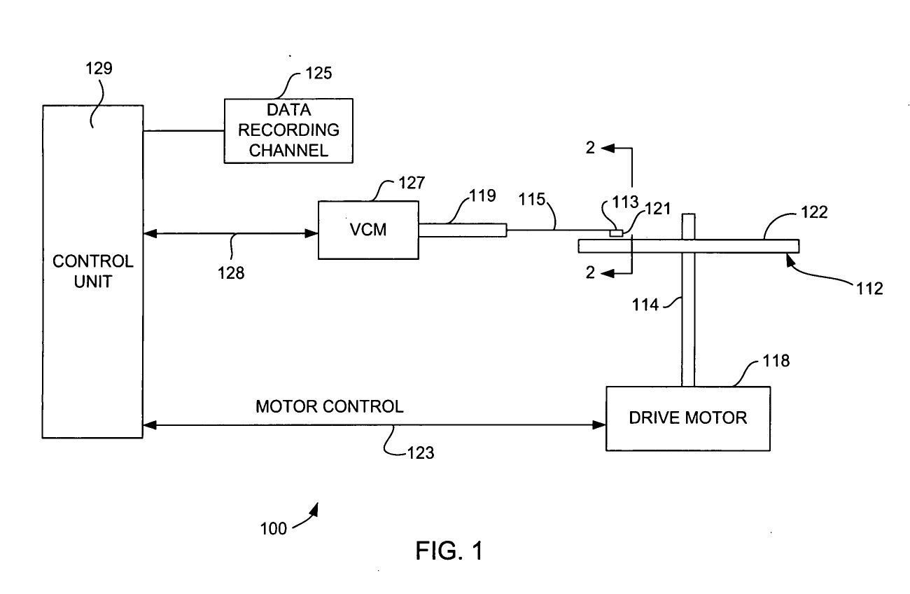

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of an annular pattern of concentric data tracks (not shown) on the magnetic disk 112.

At least one slider 113 is positioned near the magnetic disk 112, each slider 113 supporting one or more magnetic head assemblies 121. As the magnetic disk rotates, the slider 113 is moved radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports the slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

The above description of a typical magnetic disk storage system, and the accompanying illustration of FIG. 1 are for representation purposes only. It should be apparent that disk storage systems may contain a large number of disks and actuators, and each actuator may support a number of sliders.

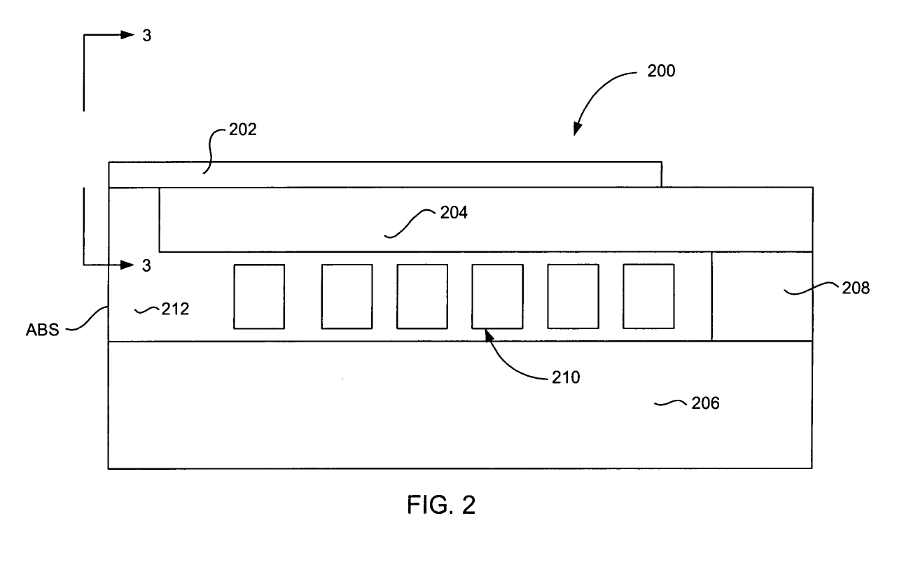

With reference to FIG. 2, a side cross section of magnetic element 200 for perpendicular recording can be seen. The write head includes a write pole 202 formed upon a flux guide layer or shaping layer 204. The write pole 202 and flux guide layer 204 are both constructed of magnetic materials. The write pole 202 is designed to contain a very large concentration of magnetic flux, and therefore, is preferably constructed of laminated layers (not shown) of high magnetic moment, high magnetic saturation (high Bsat) material such as CoFe. These magnetic layers are preferably separated by very thin layers of non-magnetic material such as chromium (Cr) and nickel chromium (CrNi) also not shown. The shaping layer 204 being much wider than the write pole (into the plane of the page) need not accommodate as high a magnetic flux concentration as the write pole 202 and can be constructed of for example NiFe or iron containing alloys.

The write element 200 also includes a return pole 206 which is magnetically connected with the shaping layer 204 by a magnetic back gap layer 208. The return pole and back gap layer can be constructed of a magnetic material such as for example NiFe iron containing alloys. An electrically conductive coil 210, formed of for example Cu passes between the shaping layer 204 and the return pole, being insulated there from by non-magnetic, electrically insulating fill material 210. Only a portion of the coil 210 is shown in FIG. 2 and is shown in cross section. Although not shown, the coil would wrap around the back gap 208. The non-magnetic, electrically non-conductive material 212 extends upward to separate the shaping layer 204 a desired distance from the ABS surface. As will be understood by those skilled in the art, the non-magnetic, electrically non-conductive fill material could be formed in several layers, and one or more chemical mechanical polishing processes may be performed between the deposition of each layer. In fact the fill 212 could be formed of layers of different materials such as for example, Al₂O₃, SiO₂ and photoresist.

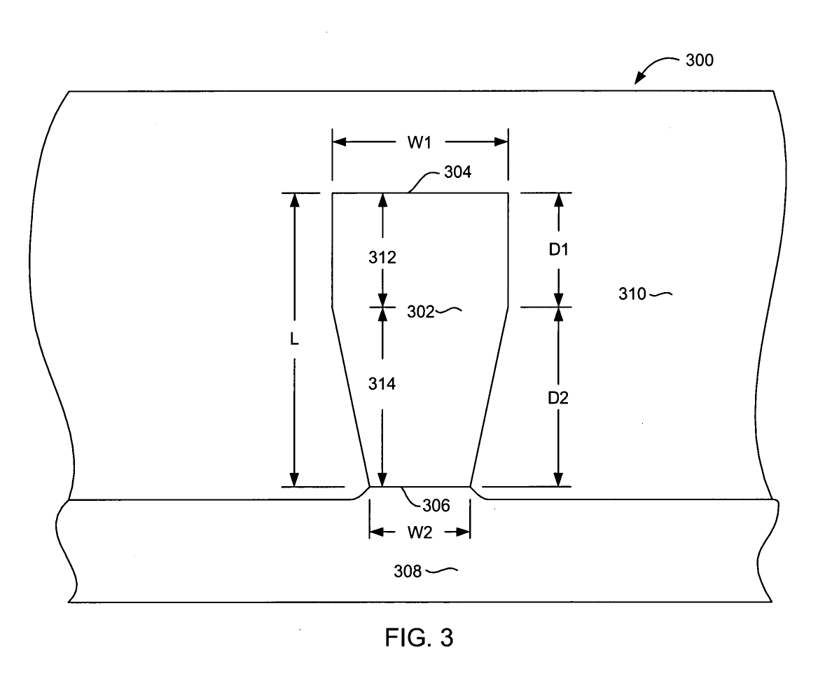

With reference now to FIG. 3, an ABS view of a portion of a write head 300, includes a write pole 302 having a trailing edge 304, and a leading edge 306. As discussed above, the write pole can be constructed of a single layer of high saturation (high Bsat) magnetic material, such as CoFe, CoNiFe or CoFeX where X is a non-magnetic element, or some other magnetic material. However, the write pole is preferably constructed of as a lamination of layers of magnetic material separated by thin layers of non-magnetic material such as chromium (Cr), nickel chromium (CrNi), or some other non-magnetic material. The magnetic layers can be a high saturation (high Bsat) material such as described above. The write pole 302 is formed upon a substrate 308 that can be a non-magnetic, electrically insulating material such as alumina. Similarly, the write pole 302 can be surrounded by a non-magnetic, electrically insulating fill layer 310 such as alumina.

The write pole is configured with first and second laterally opposed sides that are configured to define trailing region 312 having a substantially constant width, with substantially parallel laterally opposed sides, and a leading portion 314 having a tapered configuration (non-parallel sides), the width of the leading portion becoming increasingly narrower toward the leading edge 306. In other words the leading portion has non-parallel sides that define a width that decreases with decreasing distance to the leading edge. The trailing portion (constant width portion) 312 extends a predetermined distance D1 from the trailing edge 304 of the write pole. The remaining portion of the write pole 302 (tapered, or leading portion 314) extends a distance D2 from the termination of the trailing portion 312 to the leading edge 306. The write pole has a total length L, measured from the leading edge 306 to the trailing edge 304.

The length D1 of the substantially constant width trailing portion 312 can be for example about 1/10 to ½ of the total length L. In other words D1/L can be 1/10 to ½. The width W2 of the leading edge 306, measured laterally from one side to the other at the trailing edge, can be about 40% to 80% of the width W1 of the constant section 312 (ie. the width at the trailing edge 304). The configuration of the write pole 302 provides an optimal balance between avoiding skew related adjacent track writing, and also proving for strong write field near the trailing edge. Modeling has shown that the constant section 312 provides exceptional write field to the media, especially in the trailing region of the write pole 302, as well as does a write pole having a full rectangular shape. The constant section also provides for exceptional track width control because the taper does not extend all of the way to the trailing edge 304.

The tapered portion 314 effectively prevents adjacent track writing due to skew.

Modeling has shown that a write pole 302 having a tapered portion 314 that is removed from the trailing edge 304 prevents skew related adjacent track writing as well as does a write pole having a full trapezoidal shape (ie. where the taper extends all of the way to the trailing edge 304).

It should be pointed out that, while a write pole according to the present invention has been described in terms of use in a simple single pole perpendicular write head, this write pole can just as easily be used in any number of other write head designs. For example, the write pole could be used in a write head having a trailing or wrap around magnetic shield. A trailing shield design can include a magnetic layer formed at or near the ABS and which is separated from the write pole by a desire gap distance. The trailing shield can cause a canting of the write field, which increases the speed at which the magnetic field can switch, thereby increasing writing speed and efficiency. Such a trailing shield can incorporate wrap around portions which extend along the sides of the write pole and prevent adjacent track writing, and possibly also stray field writing. A leading shield, formed adjacent to and separated from the leading edge of the write pole can also be employed.

Another design in which a write pole according to the present invention can be used is a write head design wherein the write pole is disposed between a pair of return poles. In such a design, the write coil could be a helix which wraps around the write pole rather than a more commonly used pancake type write coil. Alternatively, a pair of pancake type write coils can be used with each coil being located between the write pole and its respective return pole, a so called “cusp” design. Various other write head designs may also become evident to those skilled in the art, and the novel write pole design of the present invention could be employed in those designs as well.

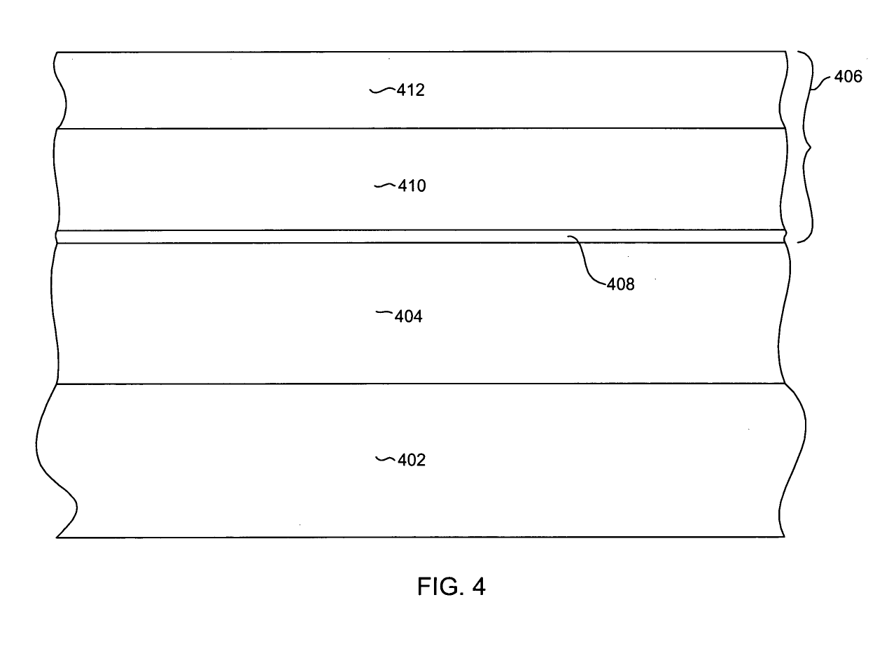

With reference now to FIGS. 4-8, one possible method for constructing a write pole according to an embodiment of the invention is described. Other methods for constructing such a write pole may be effective as well. With particular reference to FIG. 4, a substrate 402 is provided. The substrate 402 may be or include, for example, a layer of alumina (Al₂O₃) or some other non-magnetic, electrically insulating material. A layer of magnetic, electrically conductive write pole material 404 is deposited full film over the substrate 402. As mentioned above, the write pole material can be a single layer of high saturation (high Bsat) material, such as CoFe, CoNiFe, CoFeX where X a non-magnetic element or some other material, or can be a lamination of layers of magnetic material separated by thin non-magnetic layers such as chromium (Cr), nickel chromium (CrNi) or some other non-magnetic material.

With continued reference to FIG. 4, a mask structure 406 is deposited over the magnetic write pole material. Several mask structure can be used, but the mask structure 406 preferably includes a first hard mask layer 408 deposited over the write pole material layer 404. The first hard mask may be a material that is resistant to chemical mechanical polishing (CMP stop layer) such as diamond like carbon (DLC) or could be some other material such as alumina or silicon oxide. An image transfer layer 410 is then deposited over the hard mask 408. The image transfer layer is preferably a non-photoreactive material such as a soluble polyimide film such as DURIMIDE®. A layer of photosensitive mask material 412 such as photoresist is then deposited over the image transfer layer 410.

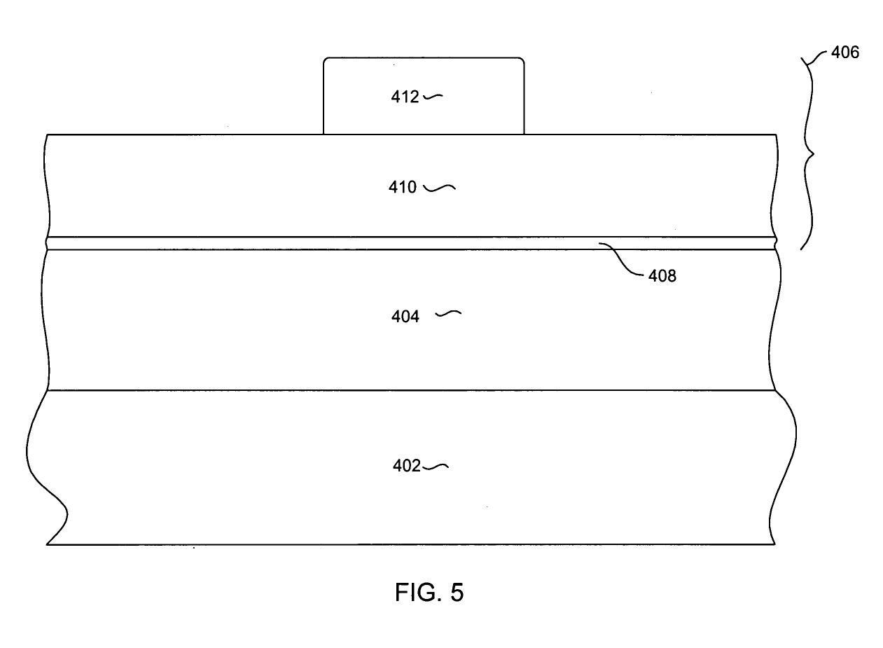

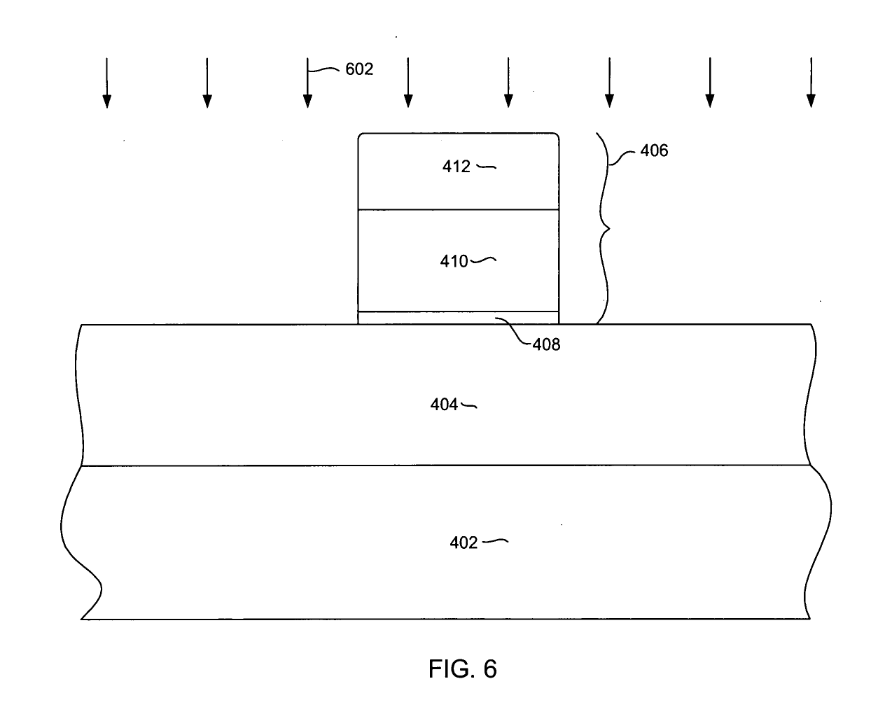

With reference now to FIG. 5, the photosensitive layer 412 is photolithographically patterned to form a photomask having a width to define a nominal track width. This width is a nominal width because a certain amount of write pole material will be consumed during ion milling as will be described in greater detail herein below. Therefore, the width of the photo mask 412 will be slightly larger than the final track width of the write pole. With reference now to FIG. 6, one or more reactive ion etch (RIE) processes 602 are performed to transfer the image of the photo mask 412 onto the underlying mask layers 410 and 408.

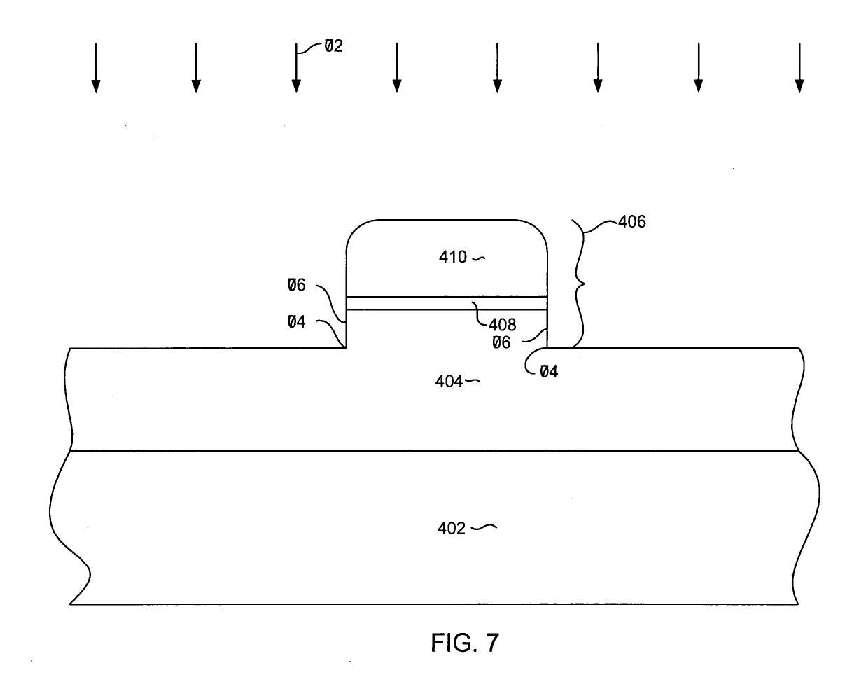

Then, with reference to FIG. 7, a first ion mill 702 is performed to form notches 704 by removing a desired amount of write pole material 404. The first ion mill 702 is performed at a substantially vertical (normal) angle to form substantially vertical walls 706 in the notches 704. This first, vertical ion mill can be performed at an angle of, for example, 15 to 45 degrees or about 30 degrees with respect to a normal to the surface of the write pole material 404, and substrate 402.

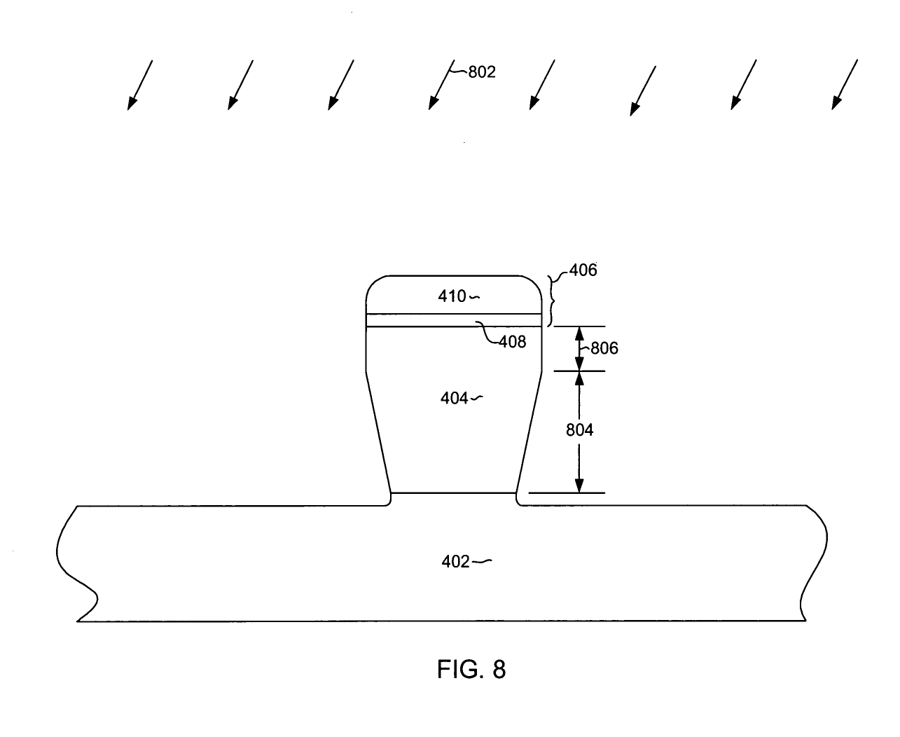

With reference to FIG. 8, a second ion mill 802 is performed. The second ion mill 802 is performed at an angle with respect to normal, in order to form a tapered shape at the sides of write pole and to trim the write pole to a desired target track width. The second ion mill can be performed at an angle of, for example, 40 to 80 degrees or about 60 degrees with respect to normal, and is preferably performed until the substrate 402 has been reached.

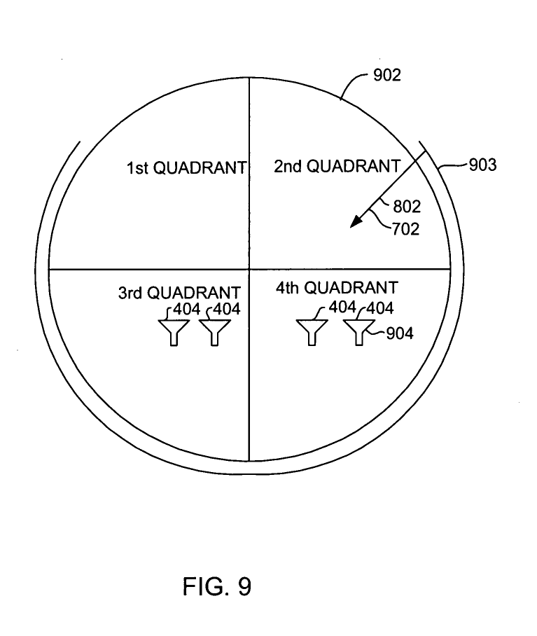

With reference to FIG. 9 the first and second ion mills 702, 802 are preferably performed in a sweeping manner (as viewed from above) so that the ion mill rotates in a semi-circular sweep 903 about the axis of the wafer 902. In this manner the ion mill sweeps about the third and fourth quadrants of the wafer, thereby directing the ion mill at both sides of the write pole. An entire rotation or 360 degree sweep is generally not performed in order to avoid shadowing from the flared portion 904 of the write pole 402. The write pole is shown enlarged in order to more clearly illustrate the flare 904 of the write pole and its orientation relative to the sweep. However, it should be understood that the thousands of such write poles 402 would actually fit onto a single wafer.

A small amount of the substrate 402 may be removed by the ion milling process 802. It should be appreciated that certain clean up procedures may also be performed after one or both of the ion mills 702, 802 to remove re-deposited material from the sides of the write pole material 402. This can be done by another sweeping ion mill. This third ion mill (not shown) can be performed at 50 to 90 degrees, or about 70 degrees with respect to normal.

The angled second ion mill 802 forms tapered sides on a leading portion 804 of the write pole material 404, leaving a trailing portion 806 formed with substantially desired side walls as desired. It will be appreciated, though, that a certain amount of material will be removed from both sides in the trailing portion. Therefore, the photo mask 412, defined as described in FIG. 5 should be constructed to have a width such that the final width of the write pole 404 in the trailing region (ie. distance between the laterally opposed sides in the trailing region) will define a desired track width for the write pole.

The relatively vertical side walls ensure an accurately defined trackwidth, as compared with a purely trapezoidal write pole, because the width of the trailing portion is not as sensitive to material removal during the taper defining ion mill 802. After the write pole 404 has been defined as described in FIG. 8, a layer of non-magnetic, electrically insulating material, such as alumina can be deposited, and a CMP or some other process can be used to remove any remaining mask structure 408, 410. Another layer of non-magnetic material can be deposited over the trailing edge of the write pole to protect it from corrosion and other damage.

It can be seen that during the various ion mill processes 702, 802 portions of the mask structure 406 are consumed. The image transfer layer ensures that sufficient mask material will remain to complete the ion milling and form the write pole 404.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A magnetic write head for perpendicular magnetic recording, comprising:
a write pole comprising a magnetic material; the write pole further comprising:
a leading edge;
a trailing edge opposite the leading edge;
a trailing portion formed proximal to the trailing edge, and having first and second substantially parallel laterally opposed sides;
a leading portion formed proximal to the leading edge of the write pole and having non-parallel sides that define a width that decreases with decreasing distance from the leading edge.

2. A write head as in claim 1, wherein:
the distance between the leading edge and the trailing edge defines a length (L);
the trailing portion of the write pole having substantially parallel side walls extends a distance D from the trailing edge; and
D is 1/10 to ½ of L.

3. A write head as in claim 1 wherein the leading portion extends substantially from the trailing portion to the leading edge.

4. A write head as in claim 1 wherein the leading portion has substantially linear, non-parallel laterally opposed side walls that extend from the trailing portion to the leading edge.

5. A write head as in claim 1 wherein the distance between the substantially parallel, laterally opposed side walls of the trailing region of the write pole define a first width W1, and wherein the leading edge defines a second width W2 that is 40% to 80% of W1.

6. A write head as in claim 1 wherein the write pole comprises a single layer of magnetic material.

7. A write head as in claim 1 wherein the write pole comprises multiple layers of magnetic material separated by layers of non-magnetic material.

8. A magnetic write head for use in a perpendicular magnetic recording system, the write head comprising:
a magnetic return pole;
a magnetic shaping layer, magnetically connected with the return pole by a magnetic back gap layer;
a magnetic write pole, magnetically connected with the shaping layer; and
an electrically conductive write coil a portion of which passes between the shaping layer and the return pole; and wherein:
the write pole has a leading edge and a trailing edge disposed opposite the leading edge;
the write pole has a trailing portion having first and second substantially parallel sides; and
the write pole has a leading portion having third and fourth non-parallel sides that define a tapered width that becomes increasing narrow toward the leading edge.

9. A write head as in claim 8 wherein the trailing portion of the write pole extends from the trailing edge to a distance D toward the leading edge, and the leading portion extends from the trailing portion to the leading edge.

10. A write head as in claim 8, wherein:
the trailing portion of the write pole extends from the trailing edge to a distance D toward the leading edge;
the distance between the leading edge and the trailing edge defines a length L; and D/L is 1/10 to ½.

11. A write head as in claim 8, wherein:
the trailing portion of the write pole has a width W1;
the leading portion has a width W2; and
W2 is 40% to 80% W1.

12. A magnetic head as in claim 8 wherein the write pole comprises a layer of high saturation (high Bsat) magnetic material.

13. A magnetic head as in claim 8 wherein the write pole comprises a plurality of layers of magnetic material separated by thin layers of non-magnetic material.

14. A method for constructing a magnetic write pole for use in a write head for perpendicular magnetic recording, the method comprising:
providing a substrate;
depositing a magnetic write pole material over the substrate;
forming a mask structure over the write pole material;
performing a first ion mill to form a notch in the magnetic write pole material, the first ion mill being performed an angle that is substantially normal to the surface of the write pole material, to configure the notch with a substantially vertical side wall, the first ion mill being performed sufficiently to form the notch to a desired depth; and
performing a second ion mill at an angle relative to normal such that additional removal of magnetic material forms a tapered portion on the write pole material below the substantially vertical side wall of the notch.

15. A method as in claim 14 wherein the second ion mill is performed sufficiently to expose the substrate.

16. A method as in claim 14 wherein the second ion mill is performed at an angle of 20 to 80 degrees with respect to normal.

17. A method as in claim 14 wherein the first ion mill is performed at an angle of 0 to 20 degrees with respect to normal, and the second ion mill is performed at an angle of 20 to 80 degrees with respect to normal.

18. A method as in claim 14, wherein the forming a mask structure further comprises:
depositing a hard mask layer;
depositing an image transfer layer;
depositing a photosensitive layer;
photolithographically patterning the photosensitive layer to form a photo mask; and
performing one or more reactive ion etch processes to transfer the image of the photo mask onto the image transfer layer and the hard mask.

19. A method as in claim 18 wherein the hard mask comprises diamond like carbon (DLC).

20. A method as in claim 18 wherein the image transfer layer comprises a soluble polyimide film.

21. A method as in claim 20 wherein the photosentive layer comprises photoresist.

22. A magnetic write head for use in a perpendicular magnetic recording system, the write head comprising;
a first magnetic return pole;
a second magnetic return pole;
a magnetic write pole, magnetically connected with the first and second return poles;
a first electrically conductive write coil a portion of which passes between the write pole and the first return pole; and
a second electrically conductive write coil a portion of which passes between the write pole and the second return pole; wherein
the write pole has a leading edge and a trailing edge disposed opposite the leading edge;
the write pole has a trailing portion having first and second substantially parallel sides; and
the write pole has a leading portion having third and fourth non-parallel sides that define a tapered width that becomes increasing narrow toward the leading edge.

23. A magnetic write head for use in a perpendicular magnetic recording system, the write head comprising;
a magnetic return pole;
a magnetic write pole, magnetically connected with the return poles;
an electrically conductive write coil that wraps around at least a portion of the write pole; and
a magnetic shield; wherein
the write pole has a leading edge and a trailing edge disposed opposite the leading edge;
the write pole has a trailing portion having first and second substantially parallel sides;
the write pole has a leading portion having third and fourth non-parallel sides that define a tapered width that becomes increasing narrow toward the leading edge and
the magnetic shield is disposed near the trailing edge of the write pole and is separated from the write pole by a gap.

24. A magnetic head as in claim 23, wherein the magnetic shield includes wrap around portions that wrap around at least a portion of the write head.

25. A magnetic write head for use in a perpendicular magnetic recording system, the
write head comprising;
a magnetic return pole;
a magnetic write pole, magnetically connected with the return pole;
an electrically conductive write coil that wraps around at least a portion of the write pole; and
a magnetic shield; wherein
the write pole has a leading edge and a trailing edge disposed opposite the leading edge;
the write pole has a trailing portion having first and second substantially parallel sides;
the write pole has a leading portion having third and fourth non-parallel sides that define a tapered width that becomes increasing narrow toward the leading edge and
the magnetic shield is disposed near the leading edge of the write pole and is separated from the write pole by a gap.

26. A magnetic head as in claim 25, wherein the magnetic shield includes wrap around portions that wrap around at least a portion of the write head.
